(19) United States
(12) Patent Application Publication
(10) Pub. No.: US 2025/0265208 A1
(43) Pub. Date: Aug. 21, 2025

(54) ELECTRONIC CONTROL UNIT AND CONTROL METHOD

(71) Applicant: Panasonic Automotive Systems Co., Ltd., Kanagawa (JP)

(72) Inventors: Yoshiharu IMAMOTO, Kanagawa (JP); Ryo HIRANO, Kanagawa (JP); Tomonori MITSUGI, Tokyo (JP); Tomohisa SEZAKI, Kanagawa (JP)

(73) Assignee: Panasonic Automotive Systems Co., Ltd., Kanagawa (JP)

(21) Appl. No.: 19/046,249

(22) Filed: Feb. 5, 2025

(30) Foreign Application Priority Data
Feb. 21, 2024 (JP) 2024-024517
Apr. 30, 2024 (JP) 2024-073339

(51) Int. Cl. G06F 13/20

(52) U.S. Cl. CPC G06F 13/20; G06F 2213/40

(57) ABSTRACT

An electronic control unit communicatively connected to a communication bus includes: a bus communication processing unit that receives a communication command from the communication bus; a communication monitor that monitors data input to or output from an untrusted execution environment including the communication command processing unit of the electronic control unit; a privileged command processing unit that processes a privileged command; a privileged command monitor that determines whether the privileged command is allowed to be executed based on a processing request that requests the privileged command processing unit to process the privileged command; and a security level coordinator that changes, based on a security level change request, a security rule for restricting processing by the communication command processing unit that is a monitoring target of the communication monitor, or the privileged command processing unit that is a monitoring target of the privileged command monitor.

### CROSS REFERENCE TO RELATED APPLICATIONS

The present application is based on and claims priority of Japanese Patent Application No. 2024-024517 filed on Feb. 21, 2024, and Japanese Patent Application No. 2024-073339 filed on Apr. 30, 2024.

### FIELD

This disclosure relates to security of electronic control units.

### BACKGROUND

As a technology for preventing the exploitation of security functions, a technology is known in which request commands to the security function issued from the host device are verified by a relay function and unauthorized request commands are blocked, as in Patent Literature (PTL) 1.

### CITATION LIST

### Patent Literature

PTL 1: Japanese Unexamined Patent Application Publication No. 2021-90103

### SUMMARY

However, the technique according to PTL 1 can be improved upon.

In view of this, the present disclosure provides a unit capable of improving upon the above related art.

### Solution to Problem

An electronic control unit according to one aspect of the present disclosure is an electronic control unit communicatively connected to a communication bus, the electronic control unit including: a bus communication processing unit that receives a communication command from the communication bus; a communication command processing unit that processes the communication command; a communication monitor that monitors data input to or output from an untrusted execution environment that includes the communication command processing unit of the electronic control unit; a privileged command processing unit that processes a privileged command with a higher security authority than the communication command processing unit; a privileged command monitor that determines whether the privileged command is allowed to be executed based on a processing request that requests the privileged command processing unit to process the privileged command; and a security level coordinator that changes a security rule in the communication monitor or in the privileged command monitor based on a security level change request from any one of the communication monitor, the privileged command monitor, and the privileged command processing unit, the security rule being for restricting processing by the communication command processing unit that is a monitoring target of the communication monitor, or the privileged command processing unit that is a monitoring target of the privileged command monitor.

It should be noted that these comprehensive or specific aspects may be realized by a system, a method, an integrated circuit, a computer program, or a recording medium such as a computer-readable CD-ROM, or may be realized by any combination of a system, a method, an integrated circuit, a computer program, and a recording medium. In addition, the recording medium may be a non-transitory recording medium.

### Advantageous Effects of Invention

The electronic control unit of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is an overall configuration diagram in an embodiment.

FIG. 2 is a diagram showing a configuration diagram of a vehicle system in the embodiment.

FIG. 3 is a diagram showing an example of a configuration diagram of an integrated ECU in the embodiment.

FIG. 4 is a diagram showing an example of the software configuration of an untrusted execution environment in the embodiment.

FIG. 5 is a diagram showing an example of the software configuration of a trusted execution environment in the embodiment.

FIG. 6 is a diagram showing an example of a security level coordinator in the embodiment.

FIG. 7 is a diagram showing an example of a definition of a security level change.

FIG. 8 is a flowchart showing an example of processing by the untrusted execution environment in the embodiment.

FIG. 9 is a flowchart showing an example of processing by the trusted execution environment (privileged command monitor) in the embodiment.

FIG. 10 is a diagram showing an example of OTA processing steps in the embodiment.

FIG. 11 is a flowchart showing an example of processing (OTA processing) by the trusted execution environment in the embodiment.

FIG. 12 is a diagram showing an example of memory access settings in the embodiment.

FIG. 13 is a diagram showing an example of memory access settings in the embodiment.

### DESCRIPTION OF EMBODIMENTS

### (Underlying Knowledge Forming Basis of the Present Disclosure)

In recent years, in-vehicle systems have become more complex in order to provide users with advanced functions such as autonomous driving. To solve the problems of increased development time and costs that accompany such complexity, there is a movement to integrate functions that were previously mounted separately in a plurality of electronic control units (ECUs) into a single ECU. In integrating ECUs, it is possible to implement the external connection function or vehicle control function mounted in the vehicle as a virtual machine or container to separate the software area. However, in an integrated ECU having a system configuration in which a function for performing external communication and a security function are coordinated, if a vulnerability in the external communication function is exploited, there is a possibility that the security function implemented in the ECU may be exploited. As a technology for preventing the exploitation of security functions, a technology is known in which request commands to the security function issued from the host device are verified by a relay function and unauthorized request commands are blocked, as in Patent PTL 1.

Incidentally, in a vehicle system, when an in-vehicle infotainment (IVI) system with external communication functions and functions that control security functions that require a high level of protection, such as vehicle travelling, stopping, and turning, are integrated into a single ECU, if vulnerabilities in the external communication functions are exploited, it could become a serious problem that threatens the safety of passengers and assets.

However, with the method of PTL 1, if a malicious program is introduced into the host device and a request command to the security function is illegally issued, it may be possible to bypass the verification of the relay function.

In order to solve the above problems, the present inventors have found an electronic control unit and the like that make it difficult to exploit security functions even if a part of the functions of the electronic control unit is exploited.

An electronic control unit according to Aspect 1 of the present disclosure is an electronic control unit communicatively connected to a communication bus, the electronic control unit including: a processor; and a non-transitory memory storing a program, the processor, by executing the program, causing the electronic control unit to operate as: a bus communication processing unit that receives a communication command from the communication bus; a communication command processing unit that processes the communication command; a communication monitor that monitors data input to or output from an untrusted execution environment that includes the communication command processing unit of the electronic control unit; a privileged command processing unit that processes a privileged command with a higher security authority than the communication command processing unit; a privileged command monitor that determines whether the privileged command is allowed to be executed based on a processing request that requests the privileged command processing unit to process the privileged command; and a security level coordinator that changes a security rule in the communication monitor or in the privileged command monitor based on a security level change request from any one of the communication monitor, the privileged command monitor, and the privileged command processing unit, the security rule being for restricting processing by the communication command processing unit that is a monitoring target of the communication monitor, or the privileged command processing unit that is a monitoring target of the privileged command monitor.

For this reason, even if a part of the functions of the electronic control unit is exploited, the security functions can be robustly protected.

An electronic control unit according to Aspect 2 of the present disclosure is the electronic control unit according to Aspect 1, wherein the communication monitor obtains first statistical information based on a part of the communication command, and transmits the security level change request to the security level coordinator based on the first statistical information.

For this reason, when an anomaly is detected based on the first statistical information based on a part of the communication command, for example, by detecting that the command is different from the communication command under normal conditions, a security level change request can be transmitted.

An electronic control unit according to Aspect 3 of the present disclosure is the electronic control unit according to Aspect 2, wherein the security level change request transmitted by the communication monitor includes a request to change the security rule for restricting, by the privileged command monitor, the processing by the privileged command processing unit.

For this reason, when an anomaly is detected based on a part of the communication command, it is possible to restrict the processing by the privileged command processing unit. For example, when the electronic control unit is removed to be placed in an environment different from normal conditions, and the like, it is possible to restrict the processing by the privileged command processing unit and cause it to behave differently from normal conditions, so that it is possible to suppress the analysis of the characteristics of the electronic control unit under normal conditions.

An electronic control unit according to Aspect 4 of the present disclosure is the electronic control unit according to any one of Aspects 1 to 3, wherein the privileged command monitor obtains second statistical information based on the privileged command, and transmits the security level change request to the security level coordinator based on the second statistical information.

For this reason, when an anomaly is detected based on the second statistical information based on the privileged command, for example, by detecting that the command is different from the privileged command under normal conditions, a security level change request can be transmitted.

An electronic control unit according to Aspect 5 of the present disclosure is the electronic control unit according to Aspect 4, wherein the security level change request transmitted by the privileged command monitor includes a request to change the security rule for restricting, by the communication monitor, the processing by the communication command processing unit.

For this reason, when an anomaly is detected based on a privileged command, it is possible to restrict the processing by the communication command processing unit. For example, since it is possible to suppress the generation of privileged commands, countermeasures can then be taken to reduce the functions in the untrusted area and restart the electronic control unit.

An electronic control unit according to Aspect 6 of the present disclosure is the electronic control unit according to any one of Aspects 1 to 5, wherein the privileged command processing unit transmits the security level change request to the security level coordinator based on a processing sequence.

For this reason, based on the processing sequence, for example, if an anomaly is detected, a security level change request can be transmitted.

An electronic control unit according to Aspect 7 of the present disclosure is the electronic control unit according to Aspect 6, wherein the security level change request transmitted by the privileged command processing unit includes a request to change the security rule for restricting, by the privileged command monitor, the processing by the privileged command processing unit.

For this reason, if an anomaly is detected based on the processing sequence, it is possible to restrict processing by the privileged command processing unit. In this way, the privileged command processing unit can switch the determination rules of the privileged command monitor in response to changes in the processing step, so that it is possible to appropriately control whether to allow the use of privileged functions based on, for example, the same command type (for example, port number).

An electronic control unit according to Aspect 8 of the present disclosure is the electronic control unit according to any one of Aspects 1 to 7, wherein the privileged command monitor further: executes memory access control for a first memory area that includes a function of exchanging data with the untrusted execution environment and is accessible only from a first trusted execution environment separated by a partition, a second memory area that includes a function other than the function included in the first trusted execution environment and is accessible only from a second trusted execution environment separated by a partition, and a third memory area that is accessible from the first trusted execution environment and the second trusted execution environment; and restricts access from the first trusted execution environment to the third memory area not to be allowed in response to a change in the security rule by the security level coordinator.

This can prohibit unauthorized memory access from untrusted areas.

A control method according to Aspect 9 of the present disclosure is a control method performed by an electronic control unit communicatively connected to a communication bus, the control method including: receiving a communication command from the communication bus; processing the communication command; monitoring input from and output to an untrusted execution environment of the electronic control unit; processing a privileged command in a trusted execution environment having a security authority higher than a security authority of the untrusted execution environment; determining whether the privileged command is allowed to be executed based on a processing request for the privileged command; and changing a security rule in the monitoring or in the determining based on a security level change request based on any one of the monitoring, the determining, and the processing of the privileged command, the security rule being for the monitoring or the determining.

For this reason, even if some of the functions of the electronic control unit are exploited, the security functions can be robustly protected.

### EMBODIMENT

### [Configuration]

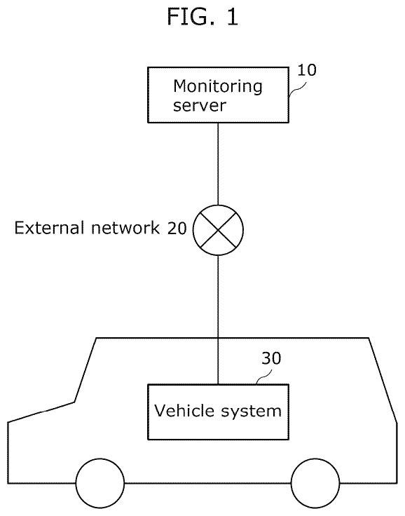

FIG. 1 is an overall configuration diagram of an embodiment of the present disclosure.

The monitoring system includes monitoring server 10 and vehicle system 30. Monitoring server 10 and vehicle system 30 are communicatively connected to each other via external network 20.

Monitoring server 10 is a device that obtains monitoring results, which are information related to the security status of vehicle system 30, from vehicle system 30, and displays the monitoring results using a graphical user interface. Monitoring server 10 is used, for example, at a security operation center for security analysts to check the monitoring results and analyze anomalies when they occur in vehicle system 30. The monitoring results may include information related to security anomalies.

External network 20 is, for example, the Internet. The communication method of external network 20 may be wired or wireless. In addition, the wireless communication method may be existing technology such as Wi-Fi (registered trademark), 3G/long term evolution (LTE), Bluetooth (registered trademark), or a V2X communication method.

Vehicle system 30 is a device that performs communication control, vehicle control, video output, and the like, monitors the security status of vehicle system 30, and notifies monitoring server 10 of the security status monitoring results. Although only one vehicle system 30 is illustrated in FIG. 1, one or more vehicle systems 30 each transmit the security status monitoring results to monitoring server 10. Details of vehicle system 30 will be described later.

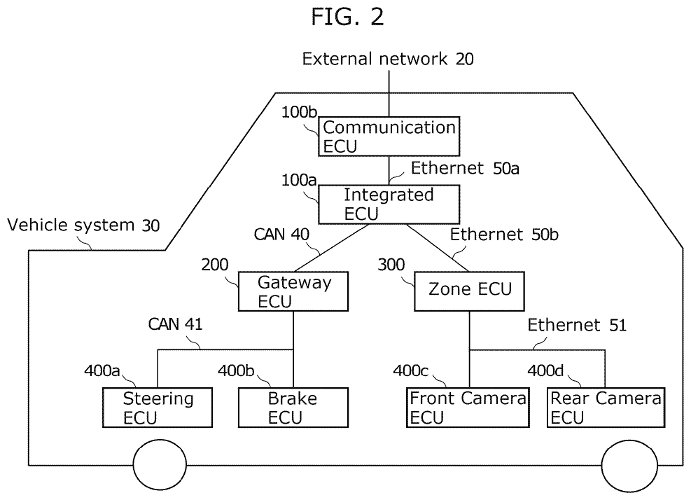

FIG. 2 is a diagram showing a configuration diagram of a vehicle system in the embodiment.

Vehicle system 30 includes integrated ECU 100a, communication ECU 100b, gateway ECU 200, Zone ECU 300, steering ECU 400a, brake ECU 400b, front camera ECU 400c, and rear camera ECU 400d.

Integrated ECU 100a and gateway ECU 200 are communicatively connected via CAN 40, which is a control area network (CAN), which is a type of network protocol. Here, the network protocol is not limited to CAN, and may be a protocol used in in-vehicle systems such as CAN-FD or FlexRay. Integrated ECU 100a and Zone ECU 300 are connected via Ethernet 50b, which is a protocol of Ethernet (registered trademark), which is a type of network protocol. Ethernet 50b is, for example, a scalable service-oriented middleware over IP (SOME/IP) protocol. Here, the network protocol may not be SOME/IP, but may be a protocol used in in-vehicle systems such as SOME/IP-SD or CAN-XL. In addition, integrated ECU 100a and monitoring server 10 are connected to each other via external network 20. CAN 41 is similar to CAN 40, and Ethernets 50a and 51 are similar to Ethernet 50b.

Integrated ECU 100a is an ECU that performs communication control to transmit and receive messages via CAN 40 and Ethernets 50a, 50b, vehicle control to instruct gateway ECU 200 and Zone ECU 300 to control the vehicle via CAN 40 and Ethernet 50b, and video output to the infotainment system and the instrument panel. In addition, integrated ECU 100a is an ECU that notifies monitoring server 10 of a security anomaly in integrated ECU 100a.

Communication ECU 100b is an ECU that communicates with external network 20. Communication ECU 100b is communicatively connected to integrated ECU 100a via Ethernet 50a.

Gateway ECU 200 is an ECU that mediates messages transmitted and received between (i) integrated ECU 100a and (ii) steering ECU 400a and brake ECU 400b.

Steering ECU 400a is an ECU that controls steering by a steering wheel mounted in the vehicle.

Brake ECU 400b is an ECU that controls the brakes mounted in the vehicle.

Zone ECU 300 is an ECU that mediates messages transmitted and received between (i) integrated ECU 100a and (ii) front camera ECU 400c and rear camera ECU 400d.

Front camera ECU 400c is an ECU that is mounted at the front of the vehicle and obtains images from a camera that captures the area in front of the vehicle.

Rear camera ECU 400d is an ECU that is mounted at the rear of the vehicle and obtains images from a camera that captures the area behind the vehicle.

Vehicle system 30 realizes control of the vehicle travelling, turning, stopping, and the like using ECUs that control the engine and body of the vehicle, in addition to steering ECU 400a, brake ECU 400b, front camera ECU 400c, and rear camera ECU 400d. In addition, advanced driving assistance functions such as automatic driving, adaptive cruise control, and automatic parking may be realized using ECUs that collect information from various sensors such as GPS.

Hereinafter, an example will be described in which the electronic control unit in the present disclosure is realized with integrated ECU 100a in vehicle system 30.

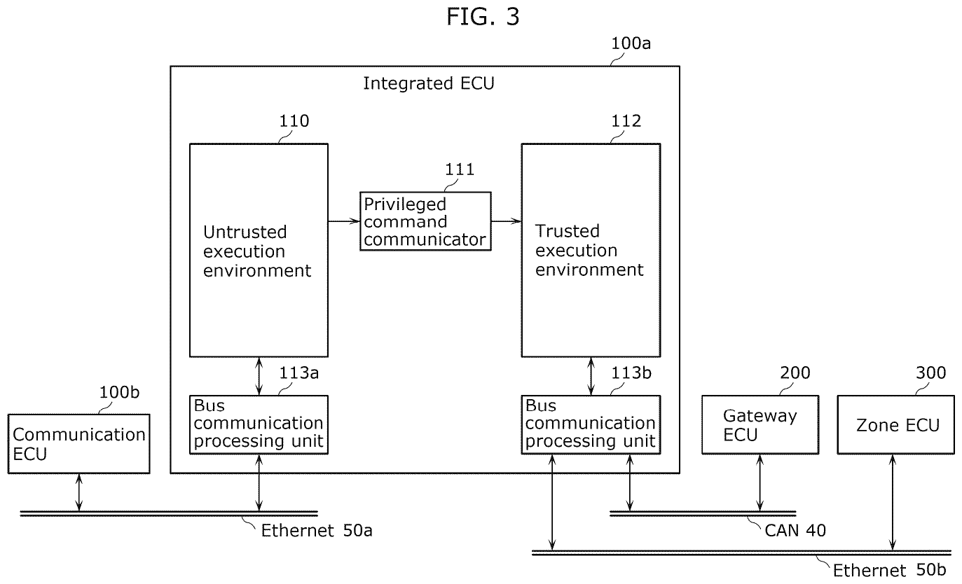

FIG. 3 is a diagram showing an example of a configuration diagram of an integrated ECU in the embodiment.

Integrated ECU 100a includes untrusted execution environment 110, privileged command communicator 111, trusted execution environment 112, and bus communication processing units 113a, 113b.

Bus communication processing unit 113a transmits and receives communication data to and from communication ECU 100b via Ethernet 50a. Bus communication processing unit 113b transmits and receives communication data to and from gateway ECU 200 via CAN 40, and transmits and receives communication data to and from Zone ECU 300 via Ethernet 50b. The communication data includes communication commands. Each of Ethernets 50a, 50b, and CAN 40 is an example of a communication bus.

Untrusted execution environment 110 and trusted execution environment 112 may be realized by a virtualization technology such as a hypervisor, or may be realized by access control or resource control provided by an OS. When untrusted execution environment 110 and trusted execution environment 112 are realized by a virtualization technology, they are realized as virtual machines. When untrusted execution environment 110 and trusted execution environment 112 are realized by an OS, they are realized as an execution area for software with restricted authority, called a container.

Untrusted execution environment 110 processes the communication data received from bus communication processing unit 113a and issues a privileged command. Untrusted execution environment 110 receives communication data with a high risk of attack obtained in communication ECU 100b via external network 20, and issues a privileged command that utilizes a function executed in trusted execution environment 112. Communication data with a high risk of attack is communication data that is highly likely to be used for a security attack.

Privileged command communicator 111 transmits and receives data between untrusted execution environment 110, whose execution authority is restricted, and trusted execution environment 112, whose execution authority is not restricted. Privileged command communicator 111 may be realized by a software communication function provided by virtualization technology or an OS, or may be realized by a communication function via hardware such as a network switch IP. In addition, the privileged command is in a communication data format such as Ethernet, disk I/O data such as a Read command or a Write command, or any predetermined data format.

Trusted execution environment 112 executes processing with a security authority higher than that of untrusted execution environment 110. Trusted execution environment 112 performs data communication via bus communication processing unit 113b. Trusted execution environment 112 issues communication data to, for example, gateway ECU 200 or Zone ECU 300, and controls vehicle system 30 to operate the functions of steering ECU 400a, brake ECU 400b, front camera ECU 400c, or rear camera ECU 400d.

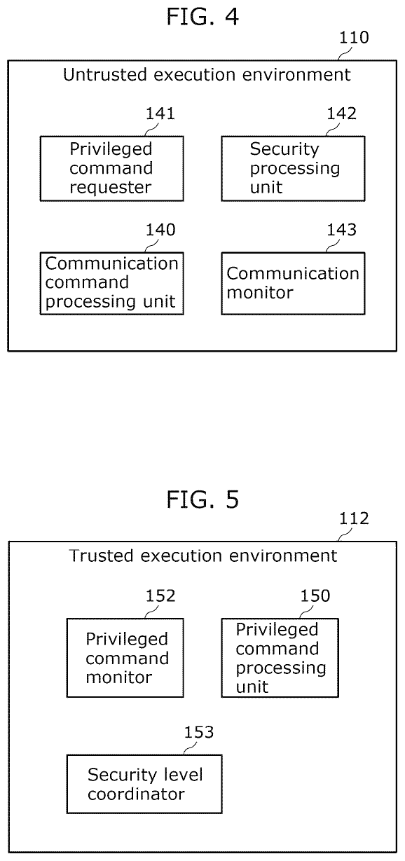

FIG. 4 is a diagram showing an example of the software configuration of the untrusted execution environment in the embodiment.

Untrusted execution environment 110 includes communication command processing unit 140, privileged command requester 141, security processing unit 142, and communication monitor 143.

Communication command processing unit 140 interprets the communication data received from bus communication processing unit 113a and passes it to privileged command requester 141. Communication command processing unit 140 processes the communication commands included in the communication data. For example, communication command processing unit 140 is realized by at least one of a communication program such as a web browser that communicates with external network 20, a disk I/O program that reads data from external storage such as a USB memory, or a communication interface program that communicates via Wi-Fi or Bluetooth. The communication data obtained by communication command processing unit 140 is data whose safety has not been verified, and there is a risk that it may contain unauthorized data by an attacker.

Privileged command requester 141 processes the communication data interpreted by communication command processing unit 140, and generates a privileged command for trusted execution environment 112. Privileged command requester 141 generates, for example, a command requesting decryption processing using the private key of trusted execution environment 112, and a control command for causing the ECU to execute control that affects the safety functions of vehicle system 30. This allows untrusted execution environment 110 to use the necessary functions, which are required by untrusted execution environment 110 that has a high risk of processing unauthorized communication data from an attacker, by having trusted execution environment 112 realize the necessary functions based on the privileged command. In addition, privileged command requester 141 generates a counter value that is counted up every time a privileged command is generated, and assigns the generated counter value and an identifier of the privileged command to be used to the privileged command to be generated, thereby enabling privileged command monitor 152, which will be described later, to generate accurate second statistical information. The monitoring accuracy of privileged command monitor 152 is improved by privileged command requester 141 registering the initial counter value to privileged command monitor 152 at the timing when integrated ECU 100a starts normally.

Security processing unit 142 restricts access to communication command processing unit 140 and privileged command requester 141 based on security rules set for security processing unit 142. For example, security processing unit 142 stops a process ID determined to be unauthorized based on the security rules, blocks a file access request to a file not permitted by the security rules, and blocks a communication request including an address, port number, or request number (including request types such as HTTP Get command, Set command, and Post command) not permitted by the security rules. In addition, the security rules are changed in response to a security level change request from security level coordinator 153 which will be described later. The security rules are stored in a memory (not shown). The memory is a non-volatile memory.

Communication monitor 143 monitors the communication data transmitted and received by communication command processing unit 140, and monitors the communication data input and output to and from untrusted execution environment 110. Accordingly, communication monitor 143 determines whether there has been unauthorized access to untrusted execution environment 110. The determination of unauthorized access may be performed based on first statistical information based on a part of the communication command. For example, the determination of unauthorized access may be performed based on one or more elements of the communication frequency (N Commands per Second), the period (every N seconds), the number of communication sessions (for example, the number of TCP sessions, the number of Netflow flows), the traffic volume (N bits per Second), the source identifier (for example, an address, process, or virtual machine ID), the consistency of the counter value included in the command (whether the counter increases or changes with the expected value), and an authenticator such as a Message Authentication Code.

Furthermore, communication monitor 143 may determine the occurrence of unauthorized access based on an anomalous state of the execution process of communication command processing unit 140 or privileged command requester 141. Communication monitor 143 may determine the occurrence of unauthorized access based on, for example, the memory usage of the process, the CPU usage, a file access violation error, or an error log generated in StackCanary, control flow integrity (CFI), or data execution prevention (DEP).

When communication monitor 143 detects unauthorized access, it notifies trusted execution environment 112 of security level change request 161, which will be described later. That is, communication monitor 143 obtains first statistical information based on a part of the communication command, and transmits security level change request 161 to security level coordinator 153 based on the first statistical information. The security level change request transmitted by communication monitor 143 includes a request to change the security rules for restricting, by privileged command monitor 152, the processing by privileged command processing unit 150.

Security level change request 161 may include an authenticator indicating the legitimacy of the source. For example, the authenticator may be at least one of a message authentication code (MAC) value for communication data generated by cryptographic technology, a Keep Alive message exchanged at regular intervals over a communication connection established when integrated ECU 100a is started, a counter value, or a hash value of previous and subsequent messages.

It should be noted that security processing unit 142 and communication monitor 143 may be executed at a security protection level higher than that of communication command processing unit 140 or privileged command requester 141, which are more likely to be attacked externally. For example, security processing unit 142 and communication monitor 143 can be realized by executing them with high system authorities in an operating system or virtualization technology using a method of isolating software execution areas using a virtual machine or a container.

FIG. 5 is a diagram showing an example of the software configuration of the trusted execution environment in the embodiment.

Trusted execution environment 112 includes privileged command monitor 152, privileged command processing unit 150, and security level coordinator 153.

Privileged command monitor 152 monitors communication data transmitted and received to and from privileged command communicator 111 or bus communication processing unit 113b by trusted execution environment 112, and monitors communication data input to trusted execution environment 112. Accordingly, privileged command monitor 152 determines whether there has been unauthorized access to trusted execution environment 112. The determination of unauthorized access may be made based on second statistical information based on the privileged command. For example, similar to communication monitor 143, the determination of unauthorized access may be performed based on one or more elements of the communication frequency (N Commands per Second), the period (every N seconds), the number of communication sessions (for example, the number of TCP sessions, the number of Netflow flows), the traffic volume (N bits per Second), the source identifier (for example, an address, process, or virtual machine ID), the consistency of the counter value included in the command (whether the counter increases or changes with the expected value), an authenticator such as a Message Authentication Code, and the time when the privileged command is transmitted after the system startup of integrated ECU 100a.

When privileged command monitor 152 detects unauthorized access, it notifies security level coordinator 153 of security level change request 161 which will be described later. That is, privileged command monitor 152 obtains second statistical information based on the privileged command, and transmits a security level change request to security level coordinator 153 based on the second statistical information.

Privileged command monitor 152 determines whether a privileged command can be executed based on a processing request of the privileged command for privileged command processing unit 150. Whether a privileged command can be executed is determined based on security rules set for privileged command monitor 152. If privileged command monitor 152 determines that the privileged command can be executed, it permits privileged command processing unit 150 to execute the privileged command, and if it determines that the privileged command cannot be executed, it does not permit privileged command processing unit 150 to execute the privileged command. The security level change request transmitted by privileged command monitor 152 includes a request to change the security rules for restricting, by communication monitor 143, the processing by communication command processing unit 140.

If privileged command monitor 152 does not permit execution of a privileged command, it may restrict access to privileged command processing unit 150. For example, privileged command monitor 152 stops a process ID determined to be unauthorized based on the security rules, blocks a file access request to a file not permitted based on the security rules, and blocks a communication request including an address, port number, or request number (including request types such as HTTP Get command, Set command, and Post command) not permitted based on the security rules. In addition, the security rules are changed in response to a security level change request from security level coordinator 153 which will be described later. The security rules are stored in a memory (not shown). The memory is a non-volatile memory.

Here, the security rules set for security processing unit 142 and the security rules set for privileged command monitor 152 may be stored in separate memory areas, or may be stored in the same memory area.

Privileged command processing unit 150 processes privileged commands with a security authority higher than that of communication command processing unit 140. Privileged command processing unit 150 performs processing that requires protection in vehicle system 30. For example, it performs processing related to functional safety, encryption processing using a secret key that should be kept secret, and program update processing for vehicle system 30 via over the air (OTA) or the like.

Privileged command processing unit 150 transmits a security level change request to security level coordinator 153 based on the processing sequence. The security level change request transmitted by privileged command processing unit 150 includes a request to change the security rules for restricting, by privileged command monitor 152, the processing by privileged command processing unit 150.

Security level coordinator 153 changes the security rules of security processing unit 142 or privileged command monitor 152 in response to a request from a predetermined processing unit such as security processing unit 142, privileged command monitor 152, or privileged command processing unit 150. Security level coordinator 153 changes the security rules in communication monitor 143 and in privileged command monitor 152 based on a security level change request from any one of communication monitor 143, privileged command monitor 152, and privileged command processing unit 150. The security rules are security rules for restricting processing by communication command processing unit 140, which is the monitoring target of communication monitor 143, or privileged command processing unit 150, which is the monitoring target of privileged command monitor 152.

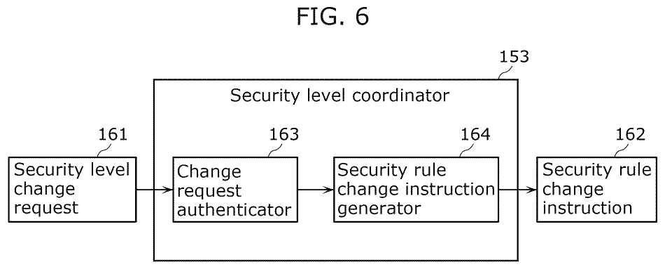

FIG. 6 is a diagram showing an example of a security level coordinator in the embodiment.

As described above, security level coordinator 153 receives security level change request 161 from security processing unit 142, privileged command monitor 152, privileged command processing unit 150, and the like, and outputs security rule change instruction 162. Security level coordinator 153 includes change request authenticator 163 and security rule change instruction generator 164.

Change request authenticator 163 verifies the validity of the security level change request. The verification of the validity may be determined by verifying the identifier (for example, process ID or address) or authenticator of the sender of the security level change request 161 described above. The authenticator may be verified by authentication using encryption technology such as a message authentication code (MAC), a Keep Alive message exchanged at regular intervals over a communication connection established with the source when integrated ECU 100a is started, the consistency of a counter value, or the presence or absence of hash values of messages before and after a message included in the message. This makes it possible to prevent unauthorized changes to security rules that exploit security level change request 161.

Security rule change instruction generator 164 generates security rules in accordance with predetermined change rules.

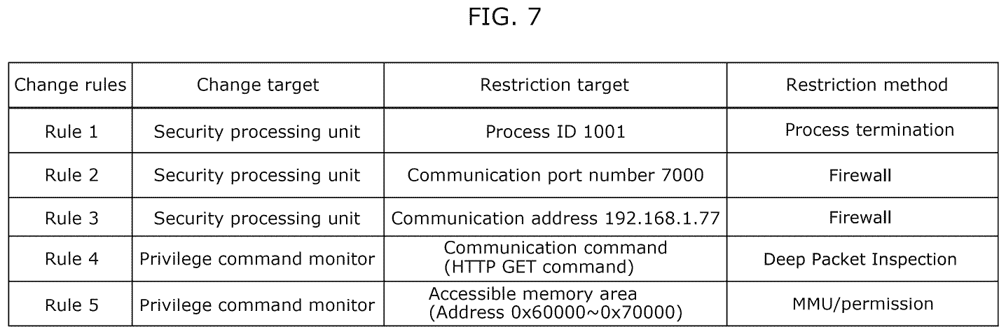

FIG. 7 is a diagram showing an example of a definition of a security level change.

Rule 1 is a rule for adding a security rule to security processing unit 142 that stops process ID 1001. For example, when an unauthorized privileged request arrives from untrusted execution environment 110 in privileged command monitor 152, by enabling Rule 1 and stopping process ID 1001 that causes the problem, unauthorized use of the functions of privileged command processing unit 150 can be prevented.

Rule 2 is a rule that blocks communication data for communication port number 7000 for security processing unit 142. Rule 3 is a rule that adds a rule to the firewall function that blocks communication from communication address 192.168.1.77 for security processing unit 142. By enabling Rule 2 or Rule 3, integrated ECU 100a can prevent external ECUs from transmitting and receiving attack data.

Rule 4 is a rule for payload-level access permission (Deep Packet Inspection) that allows or blocks the command type of privileged commands permitted by privileged command monitor 152.

Rule 5 is a rule that sets the access rights (for example, Read Only, execution permitted/prohibited, and the like) to the memory space of trusted execution environment 112 managed by privileged command monitor 152, and is a rule that defines access control from processes executed in untrusted execution environment 110.

### [Operation]

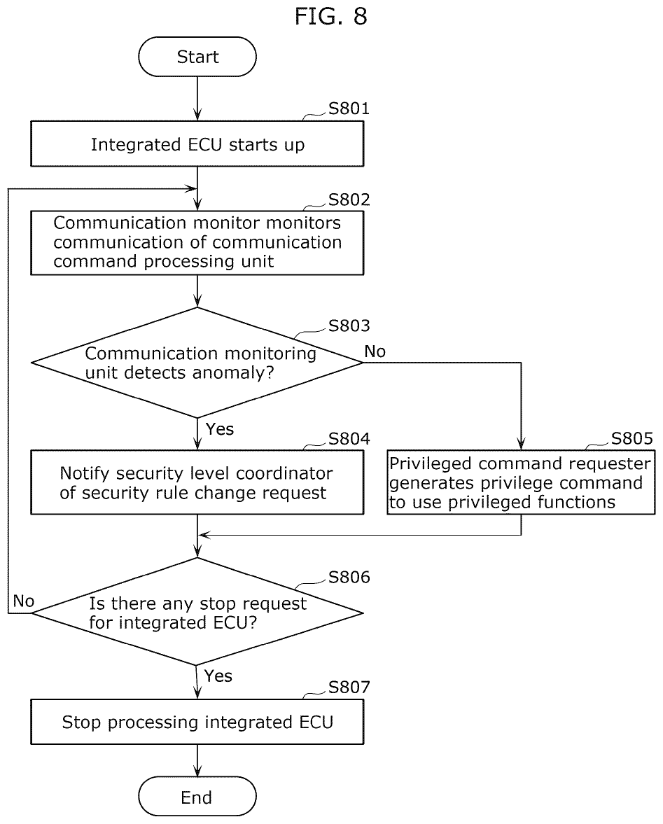

FIG. 8 is a flowchart showing an example of processing by the untrusted execution environment in the embodiment.

First, integrated ECU 100a starts up and activates untrusted execution environment 110 (S801).

Next, communication monitor 143 monitors communication of communication command processing unit 140 (S802).

Communication monitor 143 determines whether an anomaly has been detected based on the communication of communication command processing unit 140 (S803).

If communication monitor 143 detects an anomaly (Yes in S803), it notifies security level coordinator 153 of a security rule change request for restricting, by privileged command monitor 152, the processing by privileged command processing unit 150 (S804).

On the other hand, if communication monitor 143 does not detect any anomaly (No in S804), privileged command requester 141 generates a privileged command for utilizing the functions of trusted execution environment 112 (S805).

Integrated ECU 100a determines whether there is a stop request for integrated ECU 100a (S806).

If there is no stop request in integrated ECU 100a (No in S806), integrated ECU 100a repeats the processing of step S802.

If a stop request has been issued to integrated ECU 100a (Yes in S806), integrated ECU 100a performs stop processing (S807).

Accordingly, in situations where there is a high risk of external attacks, it becomes possible to restrict the use of privileged command processing unit 150 of trusted execution environment 112, making the protection of integrated ECU 100a more robust.

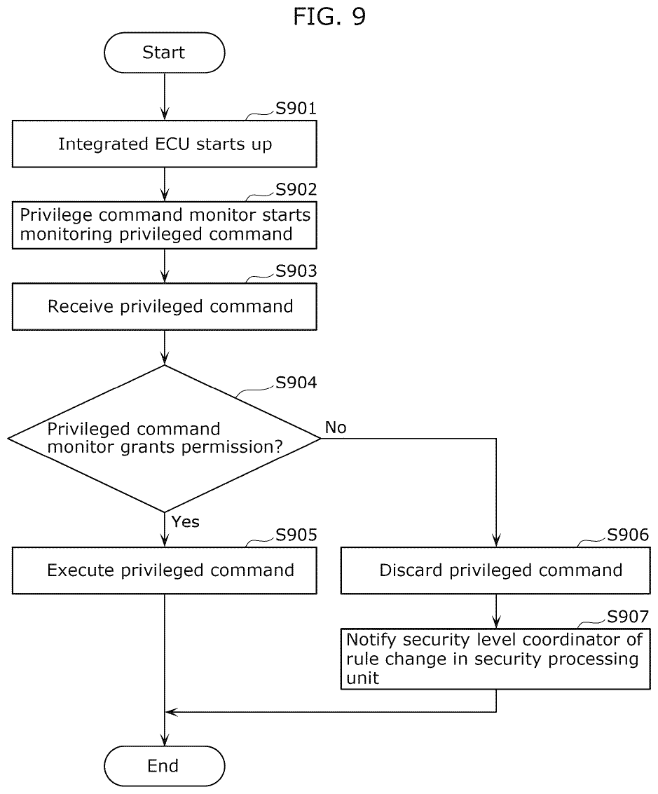

FIG. 9 is a flowchart showing an example of processing by the trusted execution environment (privileged command monitor) in the embodiment.

First, integrated ECU 100a starts up and activates trusted execution environment 112 (S901).

Next, privileged command monitor 152 monitors the privileged command received from untrusted execution environment 110 (S902).

When trusted execution environment 112 receives the privileged command (S903), privileged command monitor 152 determines whether the privileged command can be executed (S904).

If privileged command monitor 152 determines that execution of the privileged command is permitted (Yes in S904), privileged command processing unit 150 executes the permitted privileged command (S905). That is, privileged command processing unit 150 executes security processing that uses the private key managed by trusted execution environment 112 and commands related to the safety of vehicle system 30.

If privileged command monitor 152 detects an anomaly in the privileged command and execution of the privileged command is not permitted (S904 is No), the privileged command is discarded (S906).

Privileged command monitor 152 notifies security level coordinator 153 of a request to change the security rules for restricting, by communication monitor 143, the processing by security processing unit 142 (S907). The change in the security rules (change in the security level) may be executed when privileged command monitor 152 detects an anomaly in the communication of trusted execution environment 112, or may be executed based on a determination according to the state of the vehicle, such as whether it is travelling or stopped. With this configuration, integrated ECU 100a is protected from exploit of privileged processing commands when gateway ECU 200 or Zone ECU 300 connected to integrated ECU 100a becomes in an anomalous condition or is removed to cause vehicle system 30 to have an unauthorized configuration.

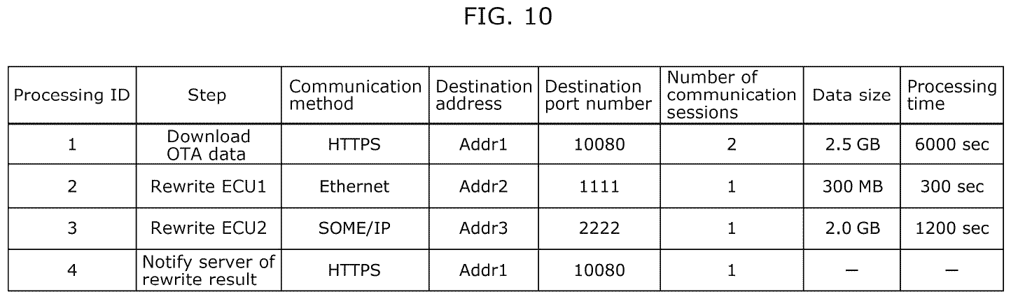

In addition, security level coordinator 153 may flexibly change the security rules of privileged command monitor 152 in response to a request from privileged command processing unit 150. In vehicle system 30, it is also possible to realize over the air (OTA) processing for rewriting the system of each ECU in privileged command processing unit 150 to make the system robust. In this case, a method for protecting privileged command processing unit 150 by privileged command monitor 152 in the OTA processing in which privileged command processing unit 150 rewrites the systems of ECU1 and ECU2 in four steps of processing ID1 to processing ID4 shown in FIG. 10 will be described. First, security level coordinator 153 sets a rule in privileged command monitor 152 that permits a communication session to an OTA server specified by Addr1 and port number 10080, as shown in processing ID1. Thereafter, privileged command processing unit 150 downloads OTA data from a server outside the vehicle, which is indicated by Addr1. Subsequently, security level coordinator 153 sets in privileged command monitor 152 a rule that permits a communication session to Addr2 and port number 1111, as shown in processing ID2. Thereafter, privileged command processing unit 150 rewrites the startup image of the ECU1 indicated by Addr2 using the downloaded OTA data. Furthermore, security level coordinator 153 sets in privileged command monitor 152 a rule that permits a communication session to Addr3 and port number 2222, as shown in processing ID3. Thereafter, privileged command processing unit 150 rewrites the startup image of the ECU2 indicated by Addr3 using the downloaded OTA data. Finally, security level coordinator 153 sets in privileged command monitor 152 a rule that permits a communication session to Addr1 and port number 10080, and notifies the OTA server of the rewrite results of the ECU1 and ECU2. After the completion of each step of processing ID1 to ID4, it is desirable to delete the related communication permission rule. In this way, by dynamically changing the rules of the security monitor, it is possible to reduce the risk that privileged command processing unit 150 will accept an unauthorized privileged command.

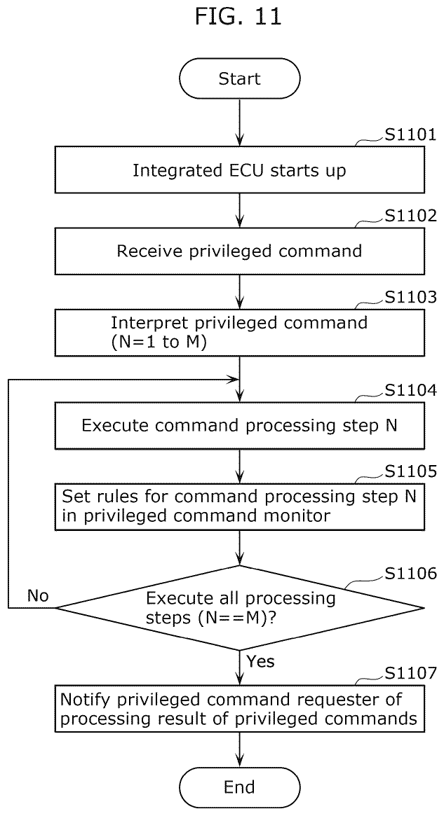

FIG. 11 is a flowchart showing an example of processing (OTA processing) by the trusted execution environment in the embodiment.

First, integrated ECU 100a starts up and activates trusted execution environment 112 (S1101).

Trusted execution environment 112 receives a privileged command from privileged command communicator 111 (S1102).

Trusted execution environment 112 interprets the Nth privileged command (S1103), and executes command processing step N based on the Nth privileged command (S1104).

Trusted execution environment 112 sets the rules for command processing step N in privileged command monitor 152 (S1105).

Trusted execution environment 112 determines whether all processing steps corresponding to all privileged commands have been executed (S1106).

If trusted execution environment 112 has not executed all processing steps (No in S1106), it repeats step S1104 for the next privileged command.

If trusted execution environment 112 has executed all processing steps (Yes in S1106), it notifies privileged command requester 141 of the processing result of the privileged commands (S1107). [Effects, etc.]

Integrated ECU 100a (electronic control unit) according to the present embodiment is an electronic control unit communicatively connected to a communication bus. Integrated ECU 100a includes bus communication processing unit 113a, communication command processing unit 140, communication monitor 143, privileged command processing unit 150, privileged command monitor 152, and security level coordinator 153. Bus communication processing unit 113a receives communication commands from Ethernet 50a (communication bus). Communication command processing unit 140 processes the communication commands. Communication monitor 143 monitors data input to and output from untrusted execution environment 110, which includes communication command processing unit 140, of integrated ECU 100a. Privileged command processing unit 150 processes the privileged command with a security authority higher than that of communication command processing unit 140. Privileged command monitor 152 determines whether the privileged command can be executed based on a processing request for the privileged command to privileged command processing unit 150. Based on a security level change request from any one of communication monitor 143, privileged command monitor 152, and privileged command processing unit 150, security level coordinator 153 changes a security rule in communication monitor 143 or in privileged command monitor 152 based on a security level change request from any one of communication monitor 143, privileged command monitor 152, and privileged command processing unit 150, the security rule being for restricting processing by communication command processing unit 140 that is a monitoring target of communication monitor 143, or privileged command processing unit 150 that is a monitoring target of privileged command monitor 152.

For this reason, even if a part of the functions of integrated ECU 100a is exploited, the security functions can be robustly protected.

In integrated ECU 100a of the present embodiment, communication monitor 143 obtains first statistical information based on a part of the communication command, and transmits the security level change request to security level coordinator 153 based on the first statistical information.

For this reason, when an anomaly is detected based on the statistical information based on a part of the first communication command, for example, by detecting that the command is different from the communication command under normal conditions, a security level change request can be transmitted.

In integrated ECU 100a of the present embodiment, the security level change request transmitted by communication monitor 143 includes a request to change the security rule for restricting, by privileged command monitor 152, the processing by privileged command processing unit 150.

For this reason, when an anomaly is detected based on a part of the communication command, it is possible to restrict the processing by privileged command processing unit 150. For example, when integrated ECU 100a is removed to be placed in an environment different from normal conditions, and the like, it is possible to restrict the processing by privileged command processing unit 150 and cause it to behave differently from normal conditions, so that it is possible to suppress the analysis of the characteristics of integrated ECU 100a under normal conditions. This makes it possible to suppress consideration of attacks on integrated ECU 100a.

In integrated ECU 100a according to the present embodiment, privileged command monitor 152 obtains second statistical information based on the privileged command, and transmits the security level change request to security level coordinator 153 based on the second statistical information.

For this reason, when an anomaly is detected based on the second statistical information based on the privileged command, for example, by detecting that the command is different from the privileged command under normal conditions, a security level change request can be transmitted.

In integrated ECU 100a of the present embodiment, the security level change request transmitted by privileged command monitor 152 includes a request to change the security rule for restricting, by communication monitor 143, the processing by communication command processing unit 140.

For this reason, when an anomaly is detected based on a privileged command, it is possible to restrict the processing by communication command processing unit 140. For example, since it is possible to suppress the generation of privileged commands, countermeasures can then be taken to reduce the functions in the untrusted area and restart integrated ECU 100a.

In integrated ECU 100a according to the present embodiment, privileged command processing unit 150 transmits the security level change request to security level coordinator 153 based on a processing sequence.

For this reason, based on the processing sequence, for example, if an anomaly is detected, a security level change request can be transmitted.

In integrated ECU 100a of the present embodiment, the security level change request transmitted by privileged command processing unit 150 includes a request to change the security rule for restricting, by privileged command monitor 152, the processing by privileged command processing unit 150.

For this reason, if an anomaly is detected based on the processing sequence, it is possible to restrict processing by the privileged command processing unit. In this way, the privileged command processing unit can switch the determination rules of the privileged command monitor in response to changes in the processing step, so that it is possible to appropriately control whether to allow the use of privileged functions based on, for example, the same command type (for example, port number).

### [Variations]

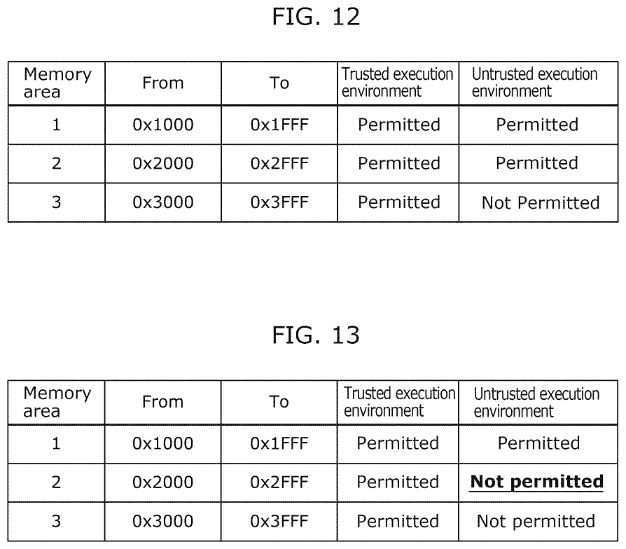

Security level coordinator 153 can also protect trusted execution environment 112 by changing information in the access memory between untrusted execution environment 110 and trusted execution environment 112. FIG. 12 and FIG. 13 show an example of memory access settings of the MMU or system in integrated ECU 100a.

Privileged command monitor 152 sets memory protection like an MMU, thereby enabling stronger separation between untrusted execution environment 110 and trusted execution environment 112. In FIG. 12, Memory area 1 (address 0x1000 to 0x1FFF) and Memory area 2 (0x2000 to 0x2FFF) permit access (read and write) by untrusted execution environment 110 and trusted execution environment 112. On the other hand, access to Memory area 3 (0x3000 to 0x3FFF) from untrusted execution environment 110 is prohibited, but access by trusted execution environment 112 is permitted.

In FIG. 13, Memory area 1 (address 0x1000 to 0x1FFF) permits access (read and write) from untrusted execution environment 110 and trusted execution environment 112. On the other hand, Memory area 2 (0x2000 to 0x2FFF) and Memory area 3 (0x3000 to 0x3FFF) prohibit access from untrusted execution environment 110, but permit access by trusted execution environment 112. In this way, by security level coordinator 153 changing the memory access rights from the settings in FIG. 12 to the settings in FIG. 13 in response to detection of an access violation by communication monitor 143, privileged command monitor 152, and privileged command processing unit 150, unauthorized memory access from untrusted execution environment 110 can be prohibited.

That is, privileged command monitor 152 executes memory access control for a first memory area that includes a function for exchanging data with untrusted execution environment 110 and is accessible only from a first trusted execution environment separated by a partition, a second memory area that includes a function other than the function included in the first trusted execution environment and is accessible only from a second trusted execution environment separated by a partition, and a third memory area that is accessible from the first trusted execution environment and the second trusted execution environment. Privileged command monitor 152 then restricts access from the first trusted execution environment to the third memory area not to be allowed in response to a change in the security rule by security level coordinator 153.

### OTHER EMBODIMENTS

As described above, the embodiment has been described as an example of the technology according to the present disclosure. However, the technology according to the present disclosure is not limited thereto, and can be applied to embodiments in which modifications, substitutions, additions, omissions, or the like are made as appropriate. For example, the following variations are also included in one embodiment of the present disclosure.

For example, in the above embodiment, an example was described in which the electronic control unit is realized by integrated ECU 100a, but this is not limited thereto, and the electronic control unit may also be realized by high-performance computing (HPC).

In addition, the order in which each step is executed in the sequence diagram is merely an example for specifically explaining the present disclosure, and may be an order other than the above. In addition, a part of the above steps may be executed simultaneously (in parallel) with other steps, or a part of the steps may not be executed.

In addition, the division of functional blocks in a block diagram is one example, and a plurality of functional blocks may be realized as one functional block, one functional block may be divided into a plurality of blocks, or a part of functions may be transferred to other functional blocks. In addition, the functions of a plurality of functional blocks having similar functions may be processed in parallel or in a time-sharing manner by a single piece of hardware or software.

In addition, each component described in the above embodiment and the like may be realized as software, or may be realized as an LSI, which is typically an integrated circuit. These may be individually integrated into one chip, or may be integrated into one chip to include a part or all of them. Here, LSI is used, but depending on the degree of integration, it may be called IC, system LSI, super LSI, or ultra LSI. In addition, the method of integration is not limited to LSI, and may be realized by a dedicated circuit (a general-purpose circuit that executes a dedicated program) or a general-purpose processor. A programmable field programmable gate array (FPGA) that can be programmed after the LSI has been manufactured, or a reconfigurable processor that can reconfigure the connections or settings of circuit cells inside the LSI may be used. Furthermore, if an integrated circuit technology that replaces an LSI appears due to advances in semiconductor technology or another technology derived therefrom, it is natural that the components may be integrated using that technology.

A system LSI is an ultra-multifunctional LSI manufactured by integrating a plurality of processing units onto a single chip, and specifically, is a computer system that includes a microprocessor, a read only memory (ROM), a random access memory (RAM), and the like. Computer programs are stored in the ROM. The system LSI achieves its functions when the microprocessor operates according to the computer programs.

In addition, one aspect of the present disclosure may be a computer program that causes a computer to execute each of the characteristic steps included in the control method mentioned above.

In addition, for example, the program may be a program for causing a computer to execute. In addition, one aspect of the present disclosure may be a non-transitory computer-readable recording medium on which such a program is recorded. For example, such a program may be recorded on a recording medium and distributed or circulated. For example, by installing the distributed program in a device having another processor and having that program executed by that processor, it becomes possible to cause that device to perform each processing described above.

In addition, forms obtained by applying various modifications to the embodiment conceived by a person skilled in the art or forms realized by arbitrarily combining the components and functions in each embodiment without departing from the spirit of the present disclosure are also included in this disclosure.

Further Information about Technical Background to this Application

The disclosures of the following patent applications including specification, drawings, and claims are incorporated herein by reference in their entirety: Japanese Patent Application No. 2024-024517 filed on Feb. 21, 2024, and Japanese Patent Application No. 2024-073339 filed on Apr. 30, 2024.

### INDUSTRIAL APPLICABILITY

According to the monitoring device of the present disclosure, even if an attacker intrudes into the vehicle system and executes an unauthorized program in the untrusted area of the monitoring device (integrated ECU), the function of the privileged command executor in the trusted area can be robustly protected. This aims to provide a safe autonomous driving and advanced driving assistance system.

1. An electronic control unit communicatively connected to a communication bus, the electronic control unit comprising:
a processor; and
a non-transitory memory storing a program,
the processor, by executing the program, causing the electronic control unit to operate as:
a bus communication processing unit that receives a communication command from the communication bus;
a communication command processing unit that processes the communication command;
a communication monitor that monitors data input to or output from an untrusted execution environment that includes the communication command processing unit of the electronic control unit;
a privileged command processing unit that processes a privileged command with a higher security authority than the communication command processing unit;
a privileged command monitor that determines whether the privileged command is allowed to be executed based on a processing request that requests the privileged command processing unit to process the privileged command; and
a security level coordinator that changes a security rule in the communication monitor or in the privileged command monitor based on a security level change request from any one of the communication monitor, the privileged command monitor, and the privileged command processing unit, the security rule being for restricting processing by the communication command processing unit that is a monitoring target of the communication monitor, or the privileged command processing unit that is a monitoring target of the privileged command monitor.

2. The electronic control unit according to claim 1, wherein
the communication monitor obtains first statistical information based on a part of the communication command, and transmits the security level change request to the security level coordinator based on the first statistical information.

3. The electronic control unit according to claim 2, wherein
the security level change request transmitted by the communication monitor includes a request to change the security rule for restricting, by the privileged command monitor, the processing by the privileged command processing unit.

4. The electronic control unit according to claim 1, wherein
the privileged command monitor obtains second statistical information based on the privileged command, and transmits the security level change request to the security level coordinator based on the second statistical information.

5. The electronic control unit according to claim 4, wherein
the security level change request transmitted by the privileged command monitor includes a request to change the security rule for restricting, by the communication monitor, the processing by the communication command processing unit.

6. The electronic control unit according to claim 1, wherein
the privileged command processing unit transmits the security level change request to the security level coordinator based on a processing sequence.

7. The electronic control unit according to claim 6, wherein
the security level change request transmitted by the privileged command processing unit includes a request to change the security rule for restricting, by the privileged command monitor, the processing by the privileged command processing unit.

8. The electronic control unit according to claim 1, wherein
the privileged command monitor further:
executes memory access control for
a first memory area that includes a function of exchanging data with the untrusted execution environment and is accessible only from a first trusted execution environment separated by a partition,
a second memory area that includes a function other than the function included in the first trusted execution environment and is accessible only from a second trusted execution environment separated by a partition, and
a third memory area that is accessible from the first trusted execution environment and the second trusted execution environment; and
restricts access from the first trusted execution environment to the third memory area not to be allowed in response to a change in the security rule by the security level coordinator.

9. A control method performed by an electronic control unit communicatively connected to a communication bus, the control method comprising:
receiving a communication command from the communication bus;
processing the communication command;
monitoring input from and output to an untrusted execution environment of the electronic control unit;
processing a privileged command in a trusted execution environment having a security authority higher than a security authority of the untrusted execution environment;
determining whether the privileged command is allowed to be executed based on a processing request for the privileged command; and
changing a security rule in the monitoring or in the determining based on a security level change request based on any one of the monitoring, the determining, and the processing of the privileged command, the security rule being for the monitoring or the determining.
